(19) United States
(12) Patent Application Publication
(10) Pub. No.: US 2023/0005397 A1
(43) Pub. Date: Jan. 5, 2023

(54) Rotating ring

(71) Applicant: Hong Zhang, Ningbo (CN)

(72) Inventor: Hong Zhang, Ningbo (CN)

(21) Appl. No.: 17/866,581

(22) Filed: Jul. 18, 2022

(30) Foreign Application Priority Data
Jan. 6, 2022 (CN) 202220018278.1

(51) Int. Cl. G09F 17/00

(52) U.S. Cl. CPC G09F 17/00; G09F 2017/0058; G09F 2017/0008

(57) ABSTRACT

The present disclosure belongs to the technical field of flagpoles, and in particular relates to a rotating ring, including a flagpole and two fixing sleeves; the two fixing sleeves are arranged outside the flagpole; each of the fixing sleeves is provided with a cover, the cover is slidably connected with the flagpole; a rotating ring body is rotatably connected to the outside of the cover, and a threaded fixing ring is in threaded connection with the outside of the cover; and the threaded fixing ring is in contact with the rotating ring body. Two groups of fixing sleeves, covers, rotating ring bodies, threaded fixing rings, balls, hanging lugs, positioning holes, external threads and other components are designed on a cylinder The two hanging lugs are used for hanging a flag. Therefore, when wind blows, the rotating ring bodies can rotate to prevent the flag from wrapping around the flagpole.

### TECHNICAL FIELD

The present disclosure relates to the field of flagpoles, in particular to a rotating ring.

### BACKGROUND

A flagpole is a sign used in various mines, enterprises and public institutions, residential areas, stations, customs wharfs, schools, stadiums, luxury hotels, city squares, and the like. The flagpoles are divided into professional flagpoles, water flooding flagpoles, knife flagpoles, stainless steel electric flagpoles, stainless steel conical flagpoles, variable-diameter flagpoles, indoor flagpoles, square flagpoles, roof flagpoles, and the like. During hanging a flag on an existing flagpole, the flag will wrap around the flagpole as a wind direction changes, which is very unsightly. Therefore, the flagpole needs to be improved.

### SUMMARY

The present disclosure aims to provide a rotating ring, which solves the following problem: during hanging a flag on an existing flagpole, the flag will wrap around the flagpole as a wind direction changes, which is very unsightly.

In order to achieve the above purpose, the present disclosure provides the following technical solution: a rotating ring, including a flagpole and two fixing sleeves; the two fixing sleeves are arranged outside the flagpole; each of the fixing sleeves is provided with a cover; the cover is slidably connected with the flagpole; a rotating ring body is rotatably connected to the outside of the cover, and a threaded fixing ring is in threaded connection with the outside of the cover; and the threaded fixing ring is in contact with the rotating ring body.

Preferably, balls are arranged in the rotating ring body, and the balls are in contact with both the threaded fixing ring and the fixing sleeve.

Preferably, a hanging lug is fixedly connected to the outside of each of the rotating ring bodies, and the hanging lug is made of stainless steel.

Preferably, the rotating ring body is provided with a positioning hole, and an inner wall of the positioning hole is provided with an internal thread.

Preferably, a top of the flagpole is fixedly connected with a limiting ball head, and the limiting ball head is made of stainless steel.

Preferably, an external thread is arranged on the cover, and the external thread and the threaded fixing ring are in threaded connection.

Compared with the prior art, the beneficial effects of the present disclosure are as follows:

Two groups of fixing sleeves, covers, rotating ring bodies, threaded fixing rings, balls, hanging lugs, positioning holes, external threads and other components are designed on a cylinder. The two hanging lugs are used for hanging a flag. In this way, when wind blows, the rotating ring bodies can rotate to prevent the flag from wrapping around the flagpole.

### BRIEF DESCRIPTION OF THE DRAWINGS

FIG. 1 is a three-dimensional diagram of an overall structure of the present disclosure;

FIG. 2 is a structurally partially exploded diagram of FIG. 1 of the present disclosure; and

FIG. 3 is a front view of a rotating ring body of FIG. 1 according to the present disclosure.

In the drawings: 1. flagpole; 2. limiting ball head; 3. fixing sleeve; 4. cover; 5. rotating ring body; 6. threaded fixing ring; 7. ball; 8. hanging lug; 9. positioning hole; 10. external thread.

### DETAILED DESCRIPTION OF THE EMBODIMENTS

The technical solutions in the embodiments of the present disclosure will be clearly and completely described below with reference to the accompanying drawings in the embodiments of the present disclosure. Obviously, the described embodiments are only a part of the embodiments of the present disclosure, rather than all the embodiments. Based on the embodiments of the present disclosure, all other embodiments obtained by those of ordinary skill in the art without creative work fall within the protection scope of the present disclosure.

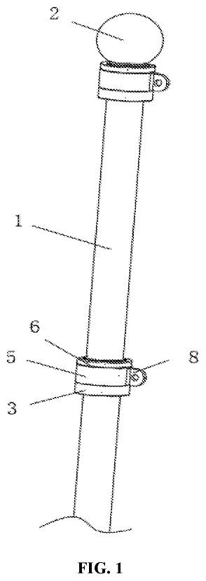

Referring to FIGS. 1-3, a rotating ring includes a flagpole 1 and two fixing sleeves 3; the two fixing sleeves 3 are arranged outside the flagpole 1; each of the fixing sleeves 3 is provided with a cover 4; the cover 4 is slidably connected with the flagpole 1; a rotating ring body 5 is rotatably connected to the outside of the cover 4, and a threaded fixing ring 6 is in threaded connection with the outside of the cover 4; and the threaded fixing ring 6 is in contact with the rotating ring body 5.

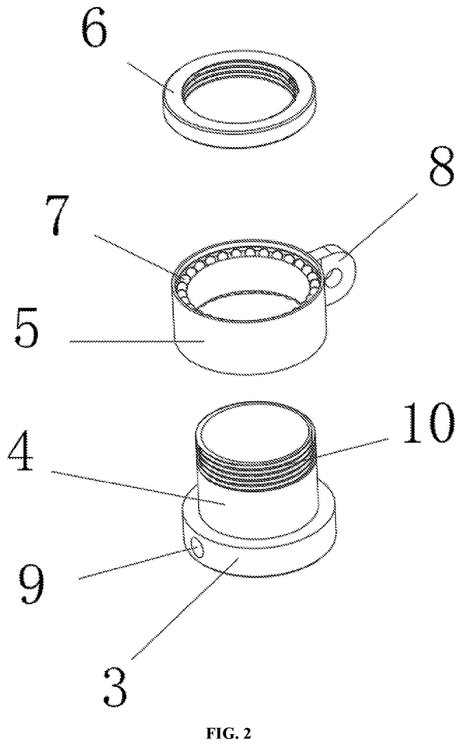

Referring to FIG. 2, balls 7 are arranged in the rotating ring body 5, and the balls 7 are in contact with both the threaded fixing ring 6 and the fixing sleeve 3. The design of the balls 7 facilitates the rotation of the rotating ring body 5.

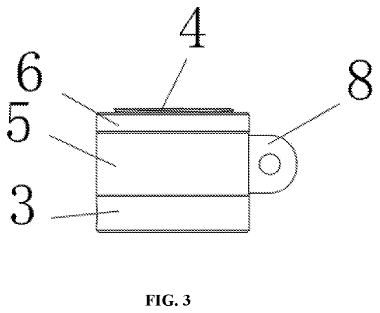

Referring to FIG. 1, FIG. 2, and FIG. 3, a hanging lug 8 is fixedly connected to the outside of each of the rotating ring bodies 5, and the hanging lug 8 is made of stainless steel. Due to the design of the hanging lugs 8, it is convenient to hang the flag.

Referring to FIG. 2, the rotating ring body 5 is provided with a positioning hole 9, and an inner wall of the positioning hole 9 is provided with an internal thread. The design of the positioning hole 9 facilitates the installation of screws for fixing the fixing sleeve 3.

Referring to FIG. 1, a top of the flagpole 1 is fixedly connected with a limiting ball head 2, and the limiting ball head 2 is made of stainless steel. The limiting ball head 2 is designed to, on the one hand, play an atractiverole, and to, on the other hand, play a limiting role.

Referring to FIG. 2, an external thread 10 is arranged on the cover 4, and the external thread 10 and the threaded fixing ring 6 are in threaded connection. The external thread 10 is designed to be in cooperation with the threaded fixing ring 6, which can limit the rotating ring body 5.

The specific implementation process of the present disclosure is as follows: During use, the rotating ring body 5 sleeves the cover 4 on the fixing sleeve 3; and the threaded fixing ring 6 is in threaded connection with the external thread 10 of the cover 4 until the threaded fixing ring 6 is in contact with the rotating ring body 5; At this time, the balls 7 in the cover 4 are in contact with the threaded fixing ring 6 and the fixing sleeve 3; and the cover 4 sleeves the flagpole 1. The other cover 4 is mounted on the flagpole 1 in the same way. The flag needing to be hung is hung on the two hanging lugs. The fixing sleeve 3 located above slides to the top of the flagpole 1 and is screwed in the positioning hole 9 with a screw; furthermore, a tail end of the screw resists against a surface of the flagpole 1; and in this way, the fixing sleeve 3 and the components on the fixing sleeve 3 are fixed. The other fixing sleeve 3 is fixed on the flagpole 1 in the same way. At this time, the flag is fixed. When a wind direction changes, the flag will drive the two rotating ring bodies 5 to rotate outside the covers 4, so that the flag is always kept in a direction consistent with the wind direction. Therefore, the phenomenon that the flag wraps around the flagpole 1 is avoided.

Although the embodiments of the present disclosure have been shown and described, it will be understood that those of ordinary skill in the art can make various changes, modifications, substitutions and transformations to these embodiments without departing from the principles and spirit of the present disclosure, and the scope of the present disclosure is defined by the appended claims and their equivalents.

1. A rotating ring comprising a flagpole (1) and two fixing sleeves (3), wherein the two fixing sleeves (3) are arranged outside the flagpole (1); each of the fixing sleeves (3) is provided with a cover (4); the cover (4) is slidably connected with the flagpole (1); a rotating ring body (5) is rotatably connected to the outside of the cover (4), and a threaded fixing ring (6) is in threaded connection with the outside of the cover (4); and the threaded fixing ring (6) is in contact with the rotating ring body (5).

2. The rotating ring according to claim 1, wherein balls (7) are arranged in the rotating ring body (5), and the balls (7) are in contact with both the threaded fixing ring (6) and the fixing sleeve (3).

3. The rotating ring according to claim 1, wherein a hanging lug (8) is fixedly connected to the outside of each of the rotating ring bodies (5), and the hanging lug (8) is made of stainless steel.

4. The rotating ring according to claim 1, wherein the rotating ring body (5) is provided with a positioning hole (9), and an inner wall of the positioning hole (9) is provided with an internal thread.

5. The rotating ring according to claim 1, wherein a top of the flagpole (1) is fixedly connected with a limiting ball head (2), and the limiting ball head (2) is made of stainless steel.

6. The rotating ring according to claim 1, wherein an external thread (10) is arranged on the cover (4), and the external thread (10) and the threaded fixing ring (6) are in threaded connection.
